(19) United States
(12) Patent Application Publication
(10) Pub. No.: US 2025/0358912 A1
(43) Pub. Date: Nov. 20, 2025

(54) MINI-LED DISPLAY DCDC CONVERSION ALLOCATION

(71) Applicant: Microsoft Technology Licensing, LLC, Redmond, WA (US)

(72) Inventor: Donghwi KIM, Kirkland, WA (US)

(21) Appl. No.: 18/664,629

(22) Filed: May 15, 2024

(51) Int. Cl. H05B 45/3725; G09G 3/34

(52) U.S. Cl. CPC H05B 45/3725; G09G 3/3426; G09G 2330/021; G09G 2330/045

(57) ABSTRACT

A display power control system may determine a brightness setting for at least one zone of the LED array, wherein the brightness setting corresponds to a select voltage applied to the at least one zone of the LED array. The display power control system may identify one or more DCDC converters of the multiple DCDC converters in the electronic device to apply the select voltage to the at least one zone of the LED array, wherein the one or more DCDC converters are identified to operate in satisfaction of the predefined power conversion efficiency condition for each DCDC converter when applying the select voltage to the at least one zone of the LED array. The display power control system may apply the voltage to the at least one zone of the LED array using the one or more DCDC converters.

### BACKGROUND

Light-emitting diodes (LED), particularly, mini-LEDs used for backlighting, can enhance displays by providing greater contrast and increased brightness compared to liquid crystal displays (LCDs). The heightened contrast provided by mini-LED backlighting enables displays to accommodate a high dynamic range (HDR) signal.

Conventional mini-LED backlit displays use a set of direct-current-to-direct-current (DCDC) converters to power LED driver circuits and have limited efficiency. Specifically, conventional mini-LED backlit displays provide the same voltage to each of the set of DCDC converters and increase/decrease this same voltage to each of the set of DCDC converters based on the current power demand of the display. However, due to its limited power conversion efficiency, power conversion loss from the conventional usage of DCDC converters in display devices is substantial. In some instances, the power conversion loss results in heating of the surface of the display device (e.g., the surface of a laptop computer), and such heating may be hazardous to users of such display devices and may also harm electrical or mechanical components of the display device in proximity to the DCDC converters. Further, the limited efficiency of the conventional operation of DCDC converters for powering mini-LED backlit displays results in an unnecessary reduction in battery life for the display device.

### SUMMARY

In some aspects, the techniques described herein relate to a method for powering a light-emitting diode (LED) array of an electronic device including multiple direct current to direct current (DCDC) converters, each DCDC converter being characterized with a predefined power conversion efficiency condition, the method including: determining a brightness setting for at least one zone of the LED array, wherein the brightness setting corresponds to a select voltage applied to the at least one zone of the LED array; identifying one or more DCDC converters of the multiple DCDC converters in the electronic device to apply the select voltage to the at least one zone of the LED array, wherein the one or more DCDC converters are identified to operate in satisfaction of the predefined power conversion efficiency condition for each DCDC converter when applying the select voltage to the at least one zone of the LED array; and applying the voltage to the at least one zone of the LED array using the one or more DCDC converters.

In some aspects, the techniques described herein relate to a computing system for powering a light-emitting diode (LED) array of an electronic device including multiple direct current to direct current (DCDC) converters, each DCDC converter being characterized with a predefined power conversion efficiency condition, the computing system including: one or more hardware processors; a pool selector executable by the one or more hardware processors and configured to identify one or more DCDC converters of the multiple DCDC converters in the electronic device to apply a select voltage to the at least one zone of the LED array, the select voltage corresponding to a brightness setting for the at least one zone of the LED array, wherein the one or more DCDC converters are identified to operate in satisfaction of the predefined power conversion efficiency condition for each DCDC converter when applying the select voltage to the at least one zone of the LED array; and a DCDC converter activator executable by the one or more processors and configured to the voltage to the at least one zone of the LED array using the one or more DCDC converter. 15.

In some aspects, the techniques described herein relate to one or more tangible processor-readable storage media embodied with instructions for executing on one or more processors and circuits of a computing device a process for powering a light-emitting diode (LED) array of an electronic device including multiple direct current to direct current (DCDC) converters, each DCDC converter being characterized with a predefined power conversion efficiency condition, the process including: determining a brightness setting for at least one zone of the LED array, wherein the brightness setting corresponds to a select voltage applied to the at least one zone of the LED array; identifying one or more DCDC converters of the multiple DCDC converters in the electronic device to apply the select voltage to the at least one zone of the LED array, wherein the one or more DCDC converters are identified to operate in satisfaction of the predefined power conversion efficiency condition for each DCDC converter when applying the select voltage to the at least one zone of the LED array; and applying the voltage to the at least one zone of the LED array using the one or more DCDC converters.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example computing environment that includes a display power control system for powering the lights of a display using one or more DCDC controllers.

FIG. 2 illustrates an example computing environment that includes a display power control system for powering lights of a display having DCDC converters located on both a computer system and the display.

FIG. 3 illustrates an example graph of an efficiency curve showing how the efficiency of power conversion of a single DCDC varies as a brightness setting achieved by a current output by the DCDC converter varies.

FIG. 4 illustrates an example graph of efficiency curves showing how the efficiency of power conversion using one or more DCDC converters varies as a brightness setting achieved by a current output of the one or more DCDC converters varies.

FIG. 5 illustrates example operations for applying a voltage to an LED array of a display device using a selected one or more DCDC converters that satisfies a power conversion efficiency condition for each of the selected DCDC controllers.

FIG. 6 illustrates an example computing device for use in implementing the described technology.

### DETAILED DESCRIPTIONS

The improved display capabilities of LED displays, compared to LCD displays, come with a power consumption cost. For instance, the power consumption of a mini-LED backlit display at a high brightness setting can reach levels as high as 15-20 Watts (W). Conventional mini-LED backlit displays provide the same voltage to each of the set of DCDC converters and increase/decrease this same voltage to each of the set of DCDC converters based on the current power demand of the display. However, the efficiency of DCDC converters varies across a range of input voltages and is less efficient at certain frequency ranges. The conventional approach of providing the same voltage to each DCDC converter of the set of DCDC converters to power the display backlighting magnifies inefficiencies when the input voltage is within less efficient frequency ranges and therefore magnifies the accompanying power conversion loss. In some instances, the power conversion loss results in heating of the surface of the display device (e.g., the surface of a laptop computer), and such heating may be hazardous to users of such display devices and may also harm electrical or mechanical components of the display device in proximity to the DCDC converters. Further, the limited efficiency of the conventional operation of DCDC converters for powering mini-LED backlit displays results in an unnecessary reduction in battery life for the display device.

The technology described addresses the deficiencies of conventional approaches to powering displays described above. The technology described herein involves the selective application of one or more of a set of DCDC converters and the selective distribution of an input voltage among the selectively applied DCDC converters, as needed, to maximize the efficiency of power conversion by the set of DCDC converters. For example, the technology described herein may add or remove a DCDC converter to/from a pool of DCDC converters powering the display when it is determined that adding/removing the DCDC converter would increase or maintain a power conversion efficiency of the DCDC converters in the pool while the DCDC converters are powering the display. Accordingly, the technology described herein can reduce the power loss resulting from powering the display compared to the power loss resulting from applying conventional approaches that merely vary the same voltage applied to each of a fixed number of DCDC converters powering the display. Consequently, by reducing the power loss compared to conventional approaches, the technology described herein also reduces the resulting thermal output of the display device and reduces the amount of battery loss compared to conventional approaches.

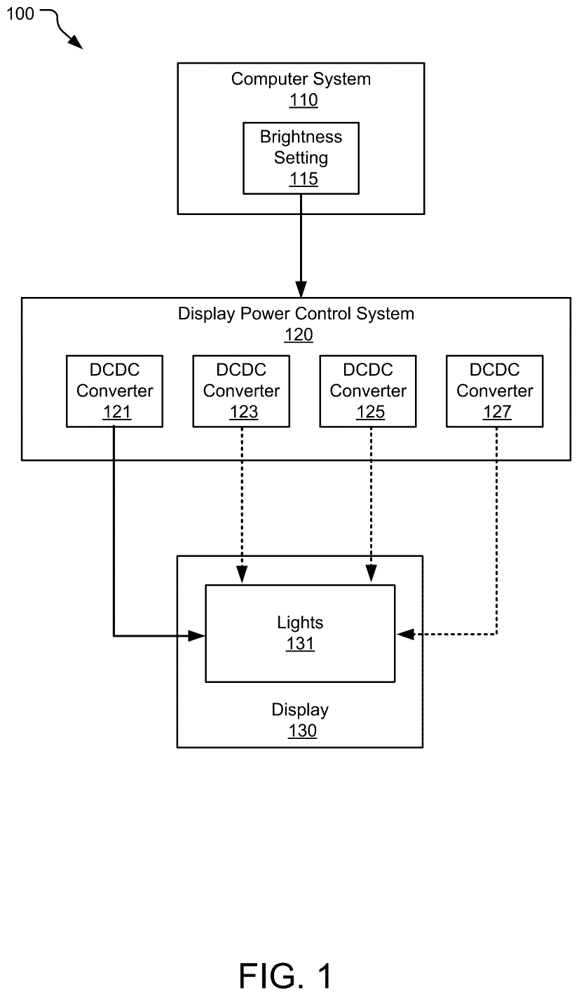

FIG. 1 illustrates an example computing environment 100 that includes a display power control system 120 for powering lights 131 of a display 130 using one or more DCDC controllers.

The computer system 110 includes the display 130 or is communicatively coupled to the display 130. For example, the computer system 110 comprises computer hardware that is connected to the display. In some implementations, the computer system 110 includes the display 130, for example, the computer system 110 is a laptop computer, a tablet device, a smartphone, or other computing device comprising its own display. In some implementations, the computer system 110 is separate from the display 130, for example, the computer system 110 is a computer connected via a wired (e.g., via hardware cable) or wireless connection. In some implementations, the computer system 110 is a remote computing device (e.g., a server) that communicates with the display 130 via a network (e.g., via the internet). For example, the display 130 may be a laptop computer including a display and the computer system is a remote server or other computing device that communicates with the laptop via the network.

The display 130 (e.g., a monitor, a touchscreen on a mobile device, or other type of display) includes lights 131 for backlighting of the display 130. For example, the lights 131 may be an array of LED lights (e.g., mini-LED lights), or other arrays of lights. In some implementations, each light of the lights 131 array provides backlighting for a respective subregion (e.g., zone) of the display 130.

The brightness setting 115 is associated with a select voltage applied to the lights 131 (e.g., mini-LED lights or other types of lights) of the display 130 to achieve a brightness defined by the brightness setting 115 (e.g., 150 nits or other brightness levels). In some implementations, the brightness setting 115 applies to the whole area of the display. In some implementations, the display includes subregions (e.g., zones) and the brightness setting 115 includes subregion-specific brightness settings for each of the subregions. For instance, brightness setting 115 includes a first brightness setting for a first subset/zone of the lights 131 responsible for providing backlighting for a first subregion/zone of the display 130, a second brightness setting for a second subset/zone of the lights 131 responsible for providing backlighting for a second subregion/zone of the display 130, and so forth. Having different brightness settings for different zones may enable better readability/viewing of the display under various conditions, for example, conditions in which ambient light is brighter on a first side of a display and is dimmer on the second side of the display. In this example, to improve readability, the brightness setting for one or more zones of the first side of display may be brighter than the brightness setting for one or more zones of the second side of the display.

The computer system 110, in some instances, determines the brightness setting 115 for the display 130. In some instances, determining the brightness setting 115 includes determining the brightness setting 115 based on detected ambient lighting conditions. For example, the computer system 110 includes or is communicatively coupled to a light sensor that detects ambient light and adjusts the brightness setting 115 (and brightness settings for subregions of the display, if applicable) based at least upon the detected brightness of the ambient light. For example, the computer system 110 may increase the brightness setting 115 for the display 130 when the ambient light brightness increases and decrease the brightness setting 115 for the display 130 (e.g., by dimming) as the ambient light brightness decreases. In some instances, determining the brightness setting 115 includes setting the brightness setting 115 based on a received input (e.g., a user input or an input from another computing device). For example, the user or other computing device specifies a brightness setting 115 and the computer system 110 receives the brightness setting 115 specified by the user or of the other computing device. In some instances, the brightness setting 115 is a default brightness setting. For example, the default brightness setting is specific to a type or model of the display 130.

The display power control system 120 powers (e.g., provides a current to, provides a voltage to, etc.) lights 131 of a display 130 using a set of DCDC converters (e.g., DCDC converter 121, DCDC converter 123, DCDC converter 125, and DCDC converter 127). For example, a DCDC converter produces a regulated (e.g., consistent) output voltage having a magnitude (and possibly polarity) that differs from an input voltage. In some instances, the input voltage to the DCDC converter is unregulated (e.g., inconsistent). In some implementations, the input voltage varies depending on a battery charging level. For example, the input voltage may be 11.4V at a 50% battery charge level in a three (3) series stacked battery and the input voltage may be 13.2V at a 100% battery charge level. DCDC The output voltage of the DCDC converter may be a fixed voltage (e.g. 7V) for miniLED two stage power delivery, the second stage being a current regulator (7 Vin and 20 mA Iout across LEDs). In some implementations the output of the DCDC converter is current regulation across LEDs. For example, an output 20 mA current across LED stackup may yield 500 nits brightness, with a diode voltage through currents of 35V. In another example, a current output of 5 mA across an LED stackup yields 150 nits brightness, with diode voltage through regulated currents of 30V.

The example display power control system 120 depicted in FIG. 1 includes four DCDC converters. However, in some implementations, the display power control system 120 may include three, two, five, ten, or other numbers of DCDC converters. In the example depicted in FIG. 1, the display power control system 120 receives or otherwise accesses a brightness setting 115 from a computer system 110, and determines a voltage needed to power the lights 131 of the display 130 to obtain the brightness setting 115 on the display 130. In some instances, determining the voltage needed to power the lights 131 includes determining the voltage to power one or more subsets of the lights 131 to achieve subregion-specific brightness settings for one or more subregions (e.g., zones) of the display 130 specified in the brightness setting 115. In some implementations, miniLED lights 131 have two stages. In the first stage, the DCDC converter receives battery voltage as input and outputs a fixed direct current. For example, the DCDC converter, in the first stage, acts as a voltage regulators and output voltage is fixed at any brightness. In some implementations, that battery voltage input and voltage regulator output is fixed at 7V and only loading (currents) are changing. In these implementations, brightness levels (e.g., 1 nits and 1000 nits) are the same at 7V in this first stage voltage regulator and an efficiency of the voltage regulator is determined by loading. In the second stage, the DCDC converter applies backlight drivers (e.g., a current regulator). The second stage may apply various currents to set dynamic brightness across diodes allocated in zones of the lights 131 (e.g. miniLED lights). For example, the second stage is current regulator (or called backlight driver). In some implementations, the second stage takes a specific voltage (e.g., 7V) as input and produces LED currents to set specific brightness across one or more zones of LED lights 131.

The display power control system 120 determines the number of DCDC converters to use to generate the voltage that will also satisfying the power conversion efficiency condition for each of the DCDC controllers. In some implementations, using the selected number of DCDC converters maximizes a power conversion efficiency for the operating pool of DCDC controllers as a whole. In some instances, maximizing the power conversion efficiency involves attaining the maximum power conversion efficiency. In some instances, maximizing the power conversion efficiency involves maintaining the power conversion efficiency within a predefined minimum and maximum power conversion efficiency values (e.g., at least 85% efficient, between 85%-95% efficient, or other predefined range). As indicated in FIG. 1 with a solid arrow, at least one DCDC converter (e.g., DCDC converter 121) is used by the display power control system 120 to power (e.g., provide a voltage to) the lights 131 based on the received brightness setting 115. As indicated in FIG. 1 via dashed arrows, in some instances and based on the select voltage required to attain the brightness setting 115 on the display 130, the display power control system 120 adds one or more additional DCDC converters (e.g., one or more of DCDC converter 123, DCDC converter 125, or DCDC converter 127) to a pool of DCDC converters used to generate the voltage to attain the brightness setting 115 on the display 130. In some implementations, the display power control system 120 adds one or more additional DCDC converters to or removes one or more DCDC converters from, the pool of DCDC converters used to generate a current to attain the brightness setting 115 on the display 130.

In some implementations, the display power control system 120 accesses a table or other data structure that lists brightness level ranges, current output ranges, or voltage output ranges over which operation of DCDC converters at various pool sizes is most efficient. For example, the table or data structure lists a first brightness level range associated with the operation of a single DCDC converter, a second brightness level range associated with the operation of two DCDC converters, a third brightness level range associated with the operation of three DCDC converters, a fourth brightness level range associated with the operation of four DCDC converters, and so forth. The display power control system 120 selects the corresponding DCDC pool size (e.g., one, two, three, four, or other number of DCDC converters) corresponding to the pool size indicated by the data structure that corresponds to the current brightness level.

The display power control system 120 provides the determined current to the lights 131 of the display 130 using the one or more DCDC converters in the pool. The display power control system 120 provides the determined voltage to the lights 131 of the display 130 using the one or more DCDC converters in the pool. In some instances, the display power control system 120 is a component of the computer system 110. In some instances, the display power control system 120 is a component of the display 130. In some instances, the display power control system is separate from but communicatively coupled to one or more of the display 130 or the computer system 110. In some instances, some of the DCDC converters (e.g., DCDC converter 121 and DCDC converter 123) are resident on the computer system 110 (e.g., in a motherboard), and some of the DCDC converters (e.g., DCDC converter 125 and DCDC converter 127).

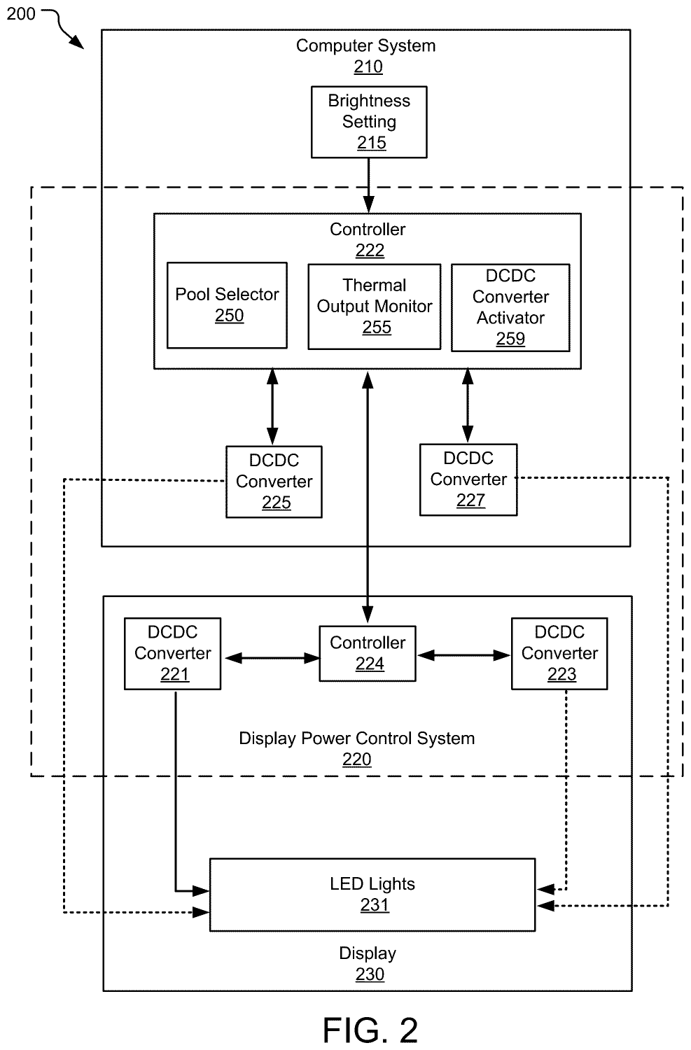

FIG. 2 illustrates an example computing environment 200 that includes a display power control system 220 for powering lights 231 of a display 230 having DCDC converters located on both a computer system and the display. Within the computing environment 200, the general functionality of the computer system 210, the display power control system 220, and the display 230 is the same or similar to that described with respect to like-named components of other figures herein. In some implementations, an electronic device comprises the computer system 210, the display power control system 220, and the display 230.

The display power control system 220 powers lights 231 of a display 230 using a set of DCDC converters (e.g., DCDC converter 221, DCDC converter 223, DCDC converter 225, and DCDC converter 227). In FIG. 2, the display power control system 120 is illustrated with dashed lines. As indicated in FIG. 2, components of the display power control system 220 are distributed among the computer system 210 and the display 230. For example, some (e.g., at least one) of the set of DCDC converters is located on a first portion of an electronic device (e.g., a display portion of a laptop device) and some (e.g., at least one) of the set of DCDC converters is located on a second portion of the electronic device (e.g., a base portion of the laptop device that includes a motherboard) separate from the first region. For example, as illustrated in FIG. 2, some of the DCDC converters may be located the computer system 210 (e.g., on a motherboard of the computer system 210) and some of the set of DCDC converters may be located on the display 230. For example, DCDC converter 221 and DCDC converter 223, as illustrated in FIG. 2, may be located on the display 130 and DCDC converter 225 and DCDC converter 227 may be located on the computer system 210. In certain implementations, when selecting a pool of DCDC converters, to minimize a thermal output in the display 230, the DCDC converters on the computer system 210 may be selected before adding, if necessary, additional DCDC converters located on the display. Similarly, in certain implementations, to minimize a thermal output in the computer system 210, the DCDC converters on the display 230 may be selected before adding, if necessary, additional DCDC converters located on the computer system 210.

In some implementations, the controller 222 is located on the computer system 210 and accesses or otherwise receives the brightness setting 215 from the computer system 210. For example, the controller 222 may comprise a pool selector 250 that accesses or otherwise receives the brightness setting 215. Each of the DCDC converters (e.g., DCDC converter 221, DCDC converter 223, DCDC converter 225, and DCDC converter 227), as instructed and based on the brightness setting 215 (that may change over time), may be included in or excluded from a pool of DCDC converters that generates a voltage to power the lights 231 of the display 230 in accordance with a target brightness setting 215. In some implementations, the controller 222 (e.g., the pool selector 250) accesses a table or other data structure that lists brightness level ranges, current output ranges, or voltage output ranges over which operation of DCDC converters at various pool sizes is most efficient. The controller 222 (e.g., the pool selector 250) selects the corresponding DCDC pool size (e.g., one, two, three, four, or other number of DCDC converters) corresponding to the pool size indicated by the data structure that corresponds to the current brightness level. In some implementations, the pool selector 250 may be implemented on one or more of the controller 222 or the controller 224. In some implementations, the pool selector may include a communication interface to receive inputs and to output the selections of DCDC controllers for the pool, hardware processors, and a controller.

The controller 222 may communicate with DCDC converters (e.g., DCDC converters 225, DCDC converter 227, DCDC converter 221, and DCDC converter 223) to attain the brightness setting 215 using the determined DCDC pool size for the brightness level. For example, the controller 222 may communicate, using the DCDC convertor activator 259, with DCDC converters (e.g., DCDC converter 225 and DCDC converter 227) of the display power control system 220 that are located on the computer system 210 and may activate or deactivate the DCDC converters as required. The controller 222 also may communicate with a controller 224 of the display power control system 220 located on the display 230 and instruct the controller 224 to communicate with DCDC converters (e.g., DCDC converter 221 and DCDC converter 223) of the display power control system 220 that are located on the display 230. Accordingly, the controller 224 may activate or deactivate, as instructed by the controller 222, the DCDC converters to generate a voltage required to attain the brightness setting 215. In some implementations, the controller 224 may activate or deactivate, as instructed by the controller 222, the DCDC converters to generate a voltage required to attain the brightness setting 215.

In some implementations, in addition to selecting a pool size of DCDC converters for satisfying the power conversion efficiency condition for each of the DCDC controllers in the selected pool, the display power control system 220 considers a temperature of one or more components of the computer system 210 and/or the display 230 when selecting particular DCDC converters for inclusion in the pool of DCDC converters of the selected pool size. In some implementations, the display power control system 220 accesses or otherwise receives, from a sensor of the computer system 210, a temperature of one or more surfaces of the computer system (e.g., a base of a laptop computer).

In an example, the controller 222, based at least upon or responsive to detecting, using a thermal output monitor 255, that the temperature of one or more components (e.g., a surface of or internal component of) of the computer system 210 is greater than a threshold (e.g., a minimum predefined temperature and/or a maximum predefined temperature), first selects (e.g., using the DCDC converter activator 259) DCDC converter 221 and DCDC converter 223 located on the display 230 before DCDC converter 225 and DCDC converter 227, which are located on the computer system 210. In this example, the display power control system 220, for a pool size of 2, may select DCDC converter 221 and DCDC converter 223 for inclusion in the pool to prevent or reduce as much as possible any further increase the surface temperature of the computer system 210. In this example, the display power control system 220, for a pool size of 3, may select (e.g., using the DCDC converter activator 259) both DCDC converter 221 and DCDC converter 223 for inclusion in the pool that are located on the display system and DCDC converter 227 on the computer system 210 so that most of the heat output (2 out of 3 DCDC converters) is on the display 230 and the least amount of the head output (1 out of 3 DCDC converters) is on the computer system 210, so as to minimize any further increase the surface temperature of the computer system 210.

In an example, the controller 222, based at least upon or responsive to detecting (e.g., using the thermal output monitor 255) that the temperature of one or more components (e.g., a surface of or one or more internal regions) of the display 230 is greater than a threshold, first selects (e.g., using the DCDC converter activator 259) DCDC converter 225 and DCDC converter 227 located on the computer system 210 before DCDC converter 221 and DCDC converter 223, which are located on the display 230. In this example, the display power control system 220, for a pool size of 2, may select DCDC converter 225 and DCDC converter 227 for inclusion in the pool to prevent or to reduce as much as possible any increase of the temperature of the one or more components of the display 230. In this example, the display power control system 220, for a pool size of 3, may select both DCDC converter 225 and DCDC converter 227 for inclusion in the pool that are located on the computer system 210 and DCDC converter 221 on the display 230 so that most of the heat output (2 out of 3 DCDC converters) is on the computer system 210 and the least amount of the heat output (1 out of 3 DCDC converters) is on the display 230, to prevent or minimize any further increase in temperature to the one or more components of the display 230. Accordingly, the technology described herein can minimize a heat output in an area of an electronic computing device (e.g., that includes the display 230 and the computer system 210) by selecting DCDC converters based at least in part on a proximity to the area.

In certain implementations, one or more functions described herein as being performed by the controller 222 and its subcomponents (e.g., the pool selector 250, the thermal output monitor 255, the DCDC converter activator 259) may also be performed by the controller 224 and one or more functions described herein as being performed by the controller 224 may also be performed by the controller 222. For example, the controller 224 on the display 230 also may select a pool size associated with a particular brightness setting to satisfy a power conversion efficiency condition for each of the DCDC controllers in the selected pool and may instruct, based on the brightness setting 215, the controller 224 of the computer system 210 to communicate with DCDC converters (e.g., DCDC converter 225 and DCDC converter 227) of the computer system 210. In some implementations, satisfying the power conversion efficiency condition for each of the DCDC controllers in the selected pool maximizes a power conversion efficiency for the operating pool of DCDC controllers as a whole. Accordingly, the controller 222 may activate or deactivate, as instructed by the controller 224, the DCDC converter 225 and/or the DCDC converter 227, as needed, to generate a voltage required to attain the brightness setting 215. In some implementations, the controller 222 may activate or deactivate, as instructed by the controller 224, the DCDC converter 225 and/or the DCDC converter 227, as needed, to generate a voltage required to attain the brightness setting 215.

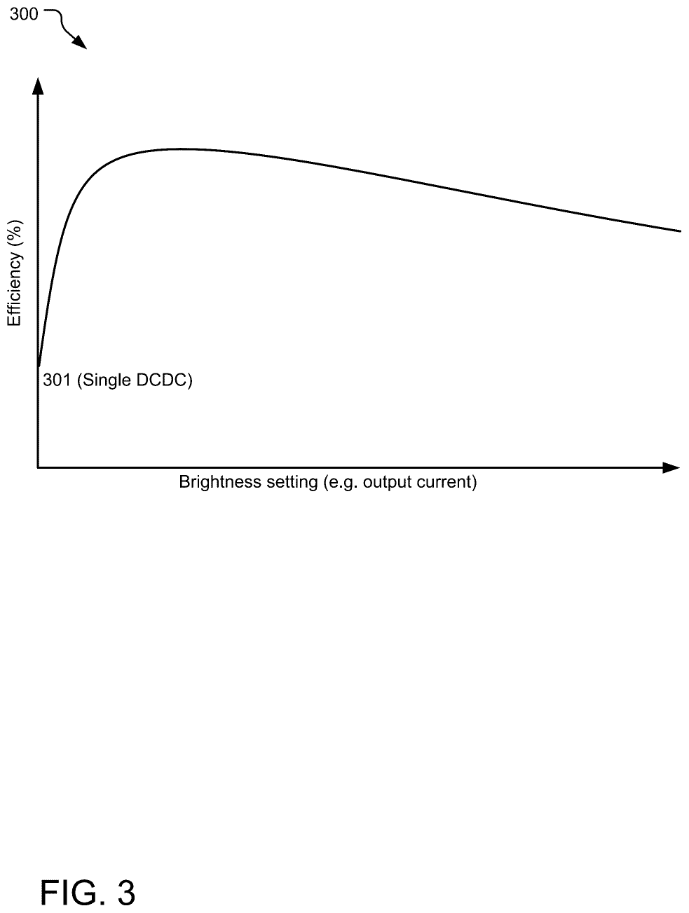

FIG. 3 illustrates an example graph 300 of an efficiency curve 301 showing how the efficiency of power conversion of a single DCDC varies as a brightness setting achieved by a current output by the DCDC converter varies. For example, the output current is proportional to the output voltage. As shown by the curve 301, the power conversion efficiency increases as the brightness level is increased until the power conversion efficiency reaches a maximum. After the maximum power conversion efficiency is reached and as the brightness setting is further increased, the power conversion efficiency begins to decrease and continues to decrease as the brightness setting is further increased. Accordingly, operation of a single DCDC to provide voltage for display backlighting is less efficient at brightness levels both below and above a brightness level at which the maximum power conversion efficiency is reached. For example, the maximum efficiency may be achieved at a brightness level corresponding to 150 nits or other brightness levels.

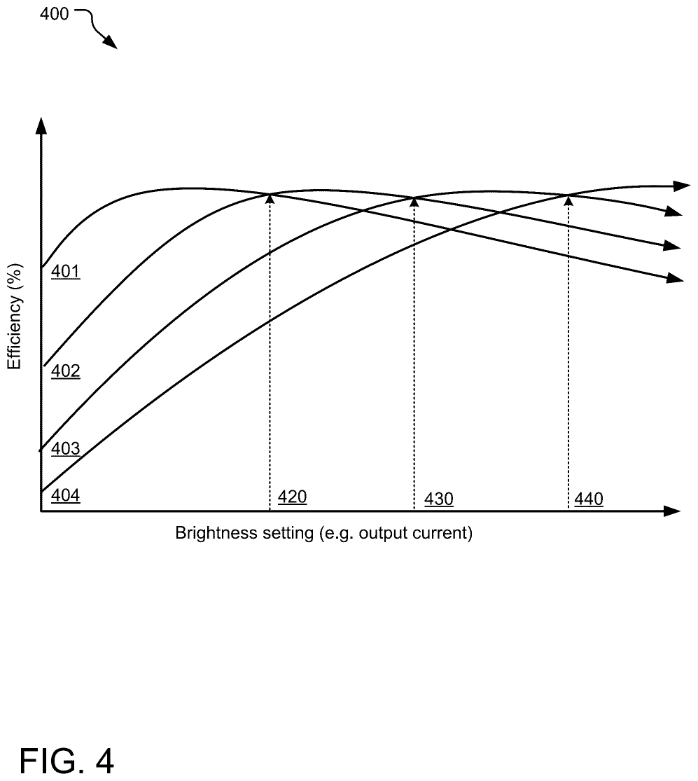

FIG. 4 illustrates an example graph 400 of efficiency curves showing how the efficiency of power conversion using one or more DCDC converters varies as a brightness setting achieved by a current output of the one or more DCDC converters varies. For example, the output current is proportional to the output voltage. Curve 401 shows the power conversion efficiency of a single DCDC converter as brightness setting varies. Curve 402 shows the power conversion efficiency of a pool of two DCDC converters as brightness setting varies. Curve 403 shows the power conversion efficiency of a pool of three DCDC converters as brightness setting varies. Curve 404 shows the power conversion efficiency of a pool of four DCDC converters as brightness setting varies.

As shown by the curve 401, the power conversion efficiency increases as the brightness level is increased until the power conversion efficiency reaches a maximum. After the maximum power conversion efficiency is reached and as the brightness setting is further increased, the power conversion efficiency begins to decrease and continues to decrease as the brightness setting is further increased. Curve 402, curve 403, and curve 404 each show a similar pattern for pools of two, three, and four DCDC converters, respectively.

As shown in graph 400, the power conversion efficiency is maximized by using only a single DCDC converter between a brightness level of 0 until brightness level 420 as illustrated by curve 401 yielding the highest efficiency within this range. Usage of a pool size of 2, 3, or 4 within this range is less efficient as illustrated by curves 402, 403, 404, respectively yielding a lower efficiency than curve 401 within this range.

From brightness level 420 until brightness level 430, the power conversion efficiency is maximized by using a pool of two DCDC converters as illustrated by curve 402 yielding the highest efficiency within this range. Usage of a pool size of 1, 3, or 4 within this range is less efficient as illustrated by curves 401, 403, 404, respectively yielding a lower efficiency than curve 402 within this range.

From brightness level 430 until brightness level 440, the power conversion efficiency is maximized by using a pool of three DCDC converters, as illustrated by curve 403 yielding the highest efficiency within this range. Usage of a pool size of 1, 2, or 4 within this range is less efficient as illustrated by curves 401, 402, 404, respectively yielding a lower efficiency than curve 403 within this range.

From brightness level 440 and higher brightness levels higher than brightness level 440, the power conversion efficiency is maximized by using a pool of four DCDC converters, as illustrated by curve 404 yielding the highest efficiency within this range. Usage of a pool size of 1, 2, or 3 within this range is less efficient as illustrated by curves 401, 402, 403, respectively yielding a lower efficiency than curve 404 within this range.

In some implementations, the display power control system may store a data structure (e.g., a table) that associates a DCDC converter pool size with these brightness level ranges over which the respective pool size of DCDC converters maximizes a power conversion efficiency compared to other possible pool sizes. The display power control system, or one or more controllers of the display power control system, may access this data structure and use it to determine the optimum pool size of DCDC converters to use to generate the voltage needed for the current brightness level that also maximizes an overall power conversion efficiency.

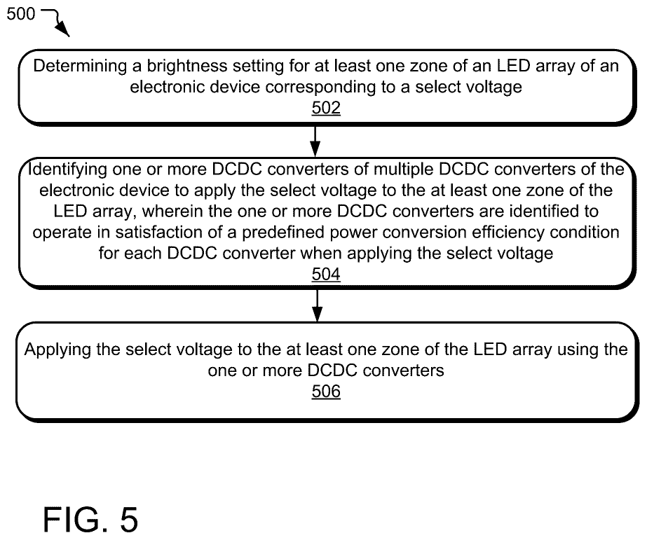

FIG. 5 illustrates example operations 500 for applying a voltage to an LED array of a display device using a selected one or more DCDC converters that satisfies a power conversion efficiency condition for each of the selected DCDC controllers. The example operations 500 include example operation 502, example operation 504, example operation 506. In some implementations, the example operations 500 are performed by a display power control system.

Example operation 502 involves an operation to determine a brightness setting for at least one zone of an LED array of an electronic device corresponding to a select voltage. In some implementations, the operation 502 involves receiving or otherwise accessing the brightness setting from a display device. In some instances, the operation 502 involves accessing a brightness setting and determining the select voltage needed to be applied to the at least one zone of the LED array to achieve the brightness setting. In some instances, the operation 502 involves determining the brightness setting corresponding to a brightness level input by the user or by another computing device. For example, the user selects a brightness level from a range or set of possible brightness settings using a slider bar, a menu, a numerical input, or other input via a user interface. In some implementations, the operation 502 involves determining the brightness setting based on a detected ambient light level that would ensure that output of the display is readable/understandable to a user.

Example operation 504 involves an operation to identify one or more DCDC converters of multiple DCDC converters of the electronic device to apply the select voltage to the at least one zone of the LED array, wherein the one or more DCDC converters are identified to operate in satisfaction of a predefined power conversion efficiency condition for each DCDC converter when applying the select voltage. Identifying the one or more DCDC converters that operate in satisfaction of a predefined power conversion efficiency condition for each DCDC converter for inclusion in the pool of DCDC converters that applies a voltage to the lighting array provides a technical benefit of increasing an overall power conversion efficiency of the pool as whole. In some implementations, the operation 504 involves retrieving (e.g., from a storage device or other memory) a data structure that associates one or more brightness level ranges, voltage output ranges, or current output ranges with a respective one or more optimum pool sizes (e.g., a pool including 1, 2, 3, 4, or other number of DCDC converters) that, over the respective brightness/voltage/current range, satisfy the power conversion efficiency condition for each DCDC converter in the pool of the respective size. In some implementations, the operation 504 involves identifying a select voltage range in the data structure corresponding to the brightness setting and identifying, in the data structure, a pool size associated with the select voltage range. For example, for a specific brightness level, a pool size of 3 DCDC converters provides a greater power conversion efficiency, compared to other possible pool sizes (e.g., 1, 2, 4, or other number of DCDC converters other than 3) to yield the output brightness setting. Example operation 504 may involve selecting a number of DCDC converters equal to the determined pool size.

In some implementations, one or more DCDC converters are located on the display and one or more DCDC converters are located on the computer system (e.g., on the motherboard) separate from the display and the operation to apply the select voltage may include selecting specific DCDC converters to minimize surface temperature of one or more of the display or a surface region of the computer system (e.g., a base of a laptop computer). For example, the operation 504 may involve determining that a current temperature a surface of the computer is greater than a threshold temperature and therefore, when selecting DCDC converters for the pool, first selects DCDC converters on the display and then, if necessary (e.g., if less than the number needed are on the display), selects one or more DCDC converters on the computer system.). In another example, the operation 504 may involve determining that a current temperature of the display is greater than a threshold temperature and therefore, when selecting DCDC converters for the pool, first selects DCDC converters on the computer system (e.g., on the motherboard) and, if necessary (e.g., if less than the number needed are on the motherboard), selects one or more DCDC converters on the display. Accordingly, the by selecting first selecting DCDC converters farthest away from an overheated area of the electronic device (e.g., display or motherboard) before selecting, if necessary, DCDC converters closest to the overheated area, the operation 504 results in the least possible amount of additional heat generated in the overheated area while still providing the sufficient number of DCDC converters to ensure efficient operation of the pool of DCDC converters.

Example operation 506 involves an operation to apply the select voltage to the at least one zone of the LED array using the one or more DCDC converters. The example operation 506 may involve activating one or more of the selected DCDC converters that are not yet activated or deactivating one or more DCDC converters that were not selected. The lights of the display device are powered at the brightness level by the selected pool of DCDC converters.

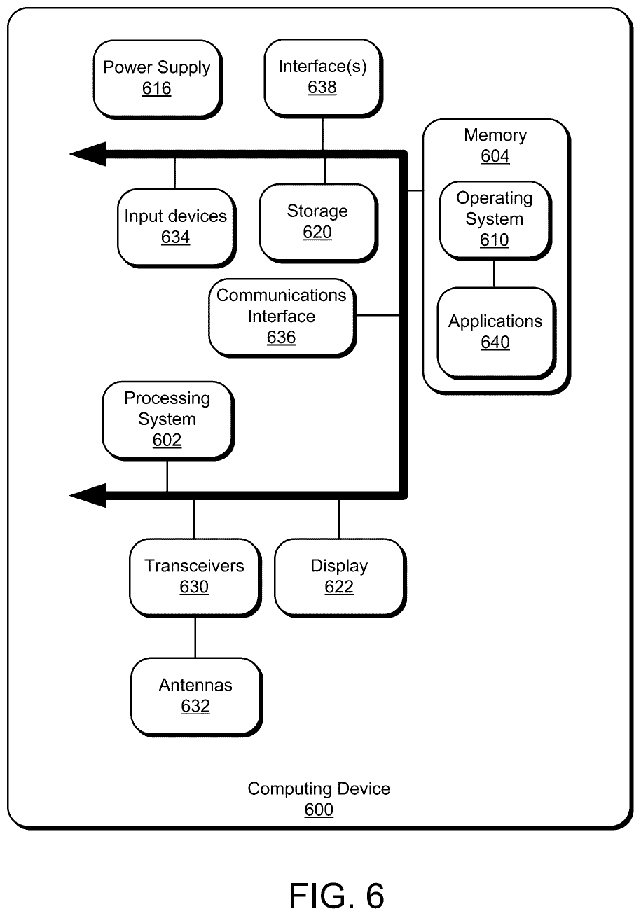

FIG. 6 illustrates an example computing device 600 for use in implementing the described technology. The computing device 600 may be a client computing device (such as a laptop computer, a desktop computer, or a tablet computer), a server/cloud computing device, an Internet-of-Things (IoT), any other type of computing device, or a combination of these options. The computing device 600 includes one or more hardware processor(s) 602 and a memory 604. The memory 604 generally includes both volatile memory (e.g., RAM) and nonvolatile memory (e.g., flash memory), although one or the other type of memory may be omitted. An operating system 610 resides in the memory 604 and is executed by the processor(s) 602. In some implementations, the computing device 600 includes and/or is communicatively coupled to storage 620.

In the example computing device 600, as shown in FIG. 6, one or more software modules, segments, and/or processors, such as applications 640, a display power control system, a controller, a pool selector, a thermal output monitor, a DCDC converter activator, and other program code and modules are loaded into the operating system 610 on the memory 604 and/or the storage 620 and executed by the processor(s) 602. The storage 620 may store a data structure that associates brightness/voltage/current level ranges with corresponding DCDC converter pool sizes that provide a greatest power conversion efficiency at the associated range, one or more temperatures of a computer system and/or display, a list of available DCDC converters and their locations on one or more of the display and/or the computer system, and other data and be local to the computing device 600 or may be remote and communicatively connected to the computing device 600. In particular, in one implementation, components of a system for classifying a dataset may be implemented entirely in hardware or in a combination of hardware circuitry and software.

The computing device 600 includes a power supply 616, which may include or be connected to one or more batteries or other power sources, and which provides power to other components of the computing device 600. The power supply 616 may also be connected to an external power source that overrides or recharges the built-in batteries or other power sources.

The computing device 600 may include one or more communication transceivers 630, which may be connected to one or more antenna(s) 632 to provide network connectivity (e.g., mobile phone network, Wi-Fi®, Bluetooth®) to one or more other servers, client devices, IoT devices, and other computing and communications devices. The computing device 600 may further include a communications interface 636 (such as a network adapter or an I/O port, which are types of communication devices). The computing device 600 may use the adapter and any other types of communication devices for establishing connections over a wide-area network (WAN) or local-area network (LAN). It should be appreciated that the network connections shown are exemplary and that other communications devices and means for establishing a communications link between the computing device 600 and other devices may be used.

The computing device 600 may include one or more input devices 634 such that a user may enter commands and information (e.g., a keyboard, trackpad, or mouse). These and other input devices may be coupled to the server by one or more interfaces 638, such as a serial port interface, parallel port, or universal serial bus (USB). The computing device 600 may further include a display 622, such as a touchscreen display.

The computing device 600 may include a variety of tangible processor-readable storage media and intangible processor-readable communication signals. Tangible processor-readable storage can be embodied by any available media that can be accessed by the computing device 600 and can include both volatile and nonvolatile storage media and removable and non-removable storage media. Tangible processor-readable storage media excludes intangible, transitory communications signals (such as signals per se) and includes volatile and nonvolatile, removable, and non-removable storage media implemented in any method, process, or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 600. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Clause 1. A method for powering a light-emitting diode (LED) array of an electronic device including multiple direct current to direct current (DCDC) converters, each DCDC converter being characterized with a predefined power conversion efficiency condition, the method comprising: determining a brightness setting for at least one zone of the LED array, wherein the brightness setting corresponds to a select voltage applied to the at least one zone of the LED array; identifying one or more DCDC converters of the multiple DCDC converters in the electronic device to apply the select voltage to the at least one zone of the LED array, wherein the one or more DCDC converters are identified to operate in satisfaction of the predefined power conversion efficiency condition for each DCDC converter when applying the select voltage to the at least one zone of the LED array; and applying the voltage to the at least one zone of the LED array using the one or more DCDC converters.

Clause 2. The method of clause 1, wherein the select voltage applied by the one or more DCDC converters causes the at least one zone of the LED array to output light at the brightness setting.

Clause 3. The method of clause 1, wherein the identifying the one or more DCDC converters of the multiple DCDC converters further comprises: determining that a temperature of a component of the electronic device is greater than a threshold temperature; and based at least upon determining that the temperature is greater than the threshold temperature, identifying the one or more DCDC converters based at least in part on a proximity of each of the multiple DCDC converters to the component.

Clause 4. The method of clause 3, wherein a first subset of the DCDC converters is resident on a first portion of the electronic device, wherein a second subset of the DCDC converters is resident on a second portion of the electronic device separate from the first portion.

Clause 5. The method of clause 4, wherein identifying the one or more DCDC converters comprises: selecting the one or more DCDC converters from the first subset of the DCDC converters only, if a number of the one or more DCDC converters is less than or equal to a number of the DCDC converters in the first subset; and selecting all of the first subset of the DCDC converters and one or more of the second subset of the DCDC converters, if the number of the one or more DCDC converters is greater than the number of the DCDC converters in the first subset.

Clause 6. The method of clause 4, wherein the first portion comprises a display portion of the electronic device.

Clause 7. The method of clause 4, wherein the first portion comprises a region outside of a display portion of the electronic device.

Clause 8. A computing system for powering a light-emitting diode (LED) array of an electronic device including multiple direct current to direct current (DCDC) converters, each DCDC converter being characterized with a predefined power conversion efficiency condition, the computing system comprising: one or more hardware processors; a pool selector executable by the one or more hardware processors and configured to identify one or more DCDC converters of the multiple DCDC converters in the electronic device to apply a select voltage to at least one zone of the LED array, the select voltage corresponding to a brightness setting for the at least one zone of the LED array, wherein the one or more DCDC converters are identified to operate in satisfaction of the predefined power conversion efficiency condition for each DCDC converter when applying the select voltage to the at least one zone of the LED array; and a DCDC converter activator executable by the one or more processors and configured to apply the voltage to the at least one zone of the LED array using the one or more DCDC converter.

Clause 9. The system of clause 8, wherein the select voltage applied by the one or more DCDC converters causes the at least one zone of the LED array to output light at the brightness setting.

Clause 10. The system of clause 8, further comprising: a thermal output monitor executable by the one or more hardware processors and configured to determine that a temperature of a component of the electronic device is greater than a threshold temperature, wherein the pool selector is further configured to identify, based at least upon determining that the temperature is greater than the threshold temperature, the one or more DCDC converters based at least in part on a proximity of each of the multiple DCDC converters to the component.

Clause 11. The system of clause 10, wherein a first subset of the DCDC converters is resident on a first portion of the electronic device, wherein a second subset of the DCDC converters is resident on a second portion of the electronic device separate from the first portion.

Clause 12. The system of clause 11, wherein identifying the one or more DCDC converters comprises: selecting the one or more DCDC converters from the first subset of the DCDC converters only, if a number of the one or more DCDC converters is less than or equal to a number of the DCDC converters in the first subset; and selecting all of the first subset of the DCDC converters and one or more of the second subset of the DCDC converters, if the number of the one or more DCDC converters is greater than the number of the DCDC converters in the first subset.

Clause 13. The system of clause 11, wherein the first portion comprises a display portion of the electronic device.

Clause 14. The system of clause 11, wherein the first portion comprises a region outside of a display portion of the electronic device, wherein the component is a surface of the electronic device.

Clause 15. One or more tangible processor-readable storage media embodied with instructions for executing on one or more processors and circuits of a computing device a process for powering a light-emitting diode (LED) array of an electronic device including multiple direct current to direct current (DCDC) converters, each DCDC converter being characterized with a predefined power conversion efficiency condition, the process comprising: determining a brightness setting for at least one zone of the LED array, wherein the brightness setting corresponds to a select voltage applied to the at least one zone of the LED array; identifying one or more DCDC converters of the multiple DCDC converters in the electronic device to apply the select voltage to the at least one zone of the LED array, wherein the one or more DCDC converters are identified to operate in satisfaction of the predefined power conversion efficiency condition for each DCDC converter when applying the select voltage to the at least one zone of the LED array; and applying the voltage to the at least one zone of the LED array using the one or more DCDC converters.

Clause 16. The or more tangible processor-readable storage media of clause 15, wherein the select voltage applied by the one or more DCDC converters causes the at least one zone of the LED array to output light at the brightness setting.

Clause 17. The one or more tangible processor-readable storage media of clause 15, wherein the identifying the one or more DCDC converters of the multiple DCDC converters further comprises: determining that a temperature of a component of the electronic device is greater than a threshold temperature; and based at least upon determining that the temperature is greater than the threshold temperature, identifying the one or more DCDC converters based at least in part on a proximity of each of the multiple DCDC converters to the component.

Clause 18. The one or more tangible processor-readable storage media of clause 17, wherein a first subset of the DCDC converters is resident on a first portion of the electronic device, wherein a second subset of the DCDC converters is resident on a second portion of the electronic device separate from the first portion.

Clause 19. The one or more tangible processor-readable storage media of clause 18, wherein identifying the one or more DCDC converters comprises: selecting the one or more DCDC converters from the first subset of the DCDC converters only, if a number of the one or more DCDC converters is less than or equal to a number of the DCDC converters in the first subset; and selecting all of the first subset of the DCDC converters and one or more of the second subset of the DCDC converters, if the number of the one or more DCDC converters is greater than the number of the DCDC converters in the first subset.

Clause 20. The one or more tangible processor-readable storage media of clause 18, wherein the first portion comprises a display portion of the electronic device.

Clause 21. A computing system for powering a light-emitting diode (LED) array of an electronic device including multiple direct current to direct current (DCDC) converters, each DCDC converter being characterized with a predefined power conversion efficiency condition, the computing system comprising: means for identifying one or more DCDC converters of the multiple DCDC converters in the electronic device to apply a select voltage to at least one zone of the LED array, the select voltage corresponding to a brightness setting for the at least one zone of the LED array, wherein the one or more DCDC converters are identified to operate in satisfaction of the predefined power conversion efficiency condition for each DCDC converter when applying the select voltage to the at least one zone of the LED array; and means for applying the voltage to the at least one zone of the LED array using the one or more DCDC converter.

Clause 22. The system of clause 21, wherein the select voltage applied by the one or more DCDC converters causes the at least one zone of the LED array to output light at the brightness setting.

Clause 23. The system of clause 21, further comprising means for determining that a temperature of a component of the electronic device is greater than a threshold temperature, wherein the means for identifying the one or more DCDC converters is further configured to identify, based at least upon determining that the temperature is greater than the threshold temperature, the one or more DCDC converters based at least in part on a proximity of each of the multiple DCDC converters to the component.

Clause 24. The system of clause 23, wherein a first subset of the DCDC converters is resident on a first portion of the electronic device, wherein a second subset of the DCDC converters is resident on a second portion of the electronic device separate from the first portion.

Clause 25. The system of clause 24, wherein the means for identifying the one or more DCDC converters is further configured to select the one or more DCDC converters from the first subset of the DCDC converters only, if a number of the one or more DCDC converters is less than or equal to a number of the DCDC converters in the first subset; and to select all of the first subset of the DCDC converters and one or more of the second subset of the DCDC converters, if the number of the one or more DCDC converters is greater than the number of the DCDC converters in the first subset.

Clause 26. The system of clause 24, wherein the first portion comprises a display portion of the electronic device.

Clause 27. The system of clause 24, wherein the first portion comprises a region outside of a display portion of the electronic device, wherein the component is a surface of the electronic device.

Some implementations may comprise an article of manufacture, which excludes software per se. An article of manufacture may comprise a tangible storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

1. A method for powering a light-emitting diode (LED) array of an electronic device including multiple direct current to direct current (DCDC) converters, each DCDC converter being characterized with a predefined power conversion efficiency condition, the method comprising:
determining a brightness setting for at least one zone of the LED array, wherein the brightness setting corresponds to a select voltage applied to the at least one zone of the LED array;
identifying one or more DCDC converters of the multiple DCDC converters in the electronic device to apply the select voltage to the at least one zone of the LED array, wherein the one or more DCDC converters are identified to operate in satisfaction of the predefined power conversion efficiency condition for each DCDC converter when applying the select voltage to the at least one zone of the LED array; and
applying the select voltage to the at least one zone of the LED array using the one or more DCDC converters.

2. The method of claim 1, wherein the select voltage applied by the one or more DCDC converters causes the at least one zone of the LED array to output light at the brightness setting.

3. The method of claim 1, wherein the identifying the one or more DCDC converters of the multiple DCDC converters further comprises:
determining that a temperature of a component of the electronic device is greater than a threshold temperature; and
based at least upon determining that the temperature is greater than the threshold temperature, identifying the one or more DCDC converters based at least in part on a proximity of each of the multiple DCDC converters to the component.

4. The method of claim 3, wherein a first subset of the DCDC converters is resident on a first portion of the electronic device, wherein a second subset of the DCDC converters is resident on a second portion of the electronic device separate from the first portion.

5. The method of claim 4, wherein identifying the one or more DCDC converters comprises:
selecting the one or more DCDC converters from the first subset of the DCDC converters only, if a number of the one or more DCDC converters is less than or equal to a number of the DCDC converters in the first subset; and
selecting all of the first subset of the DCDC converters and one or more of the second subset of the DCDC converters, if the number of the one or more DCDC converters is greater than the number of the DCDC converters in the first subset.

6. The method of claim 4, wherein the first portion comprises a display portion of the electronic device.

7. The method of claim 4, wherein the first portion comprises a region outside of a display portion of the electronic device.

8. A computing system for powering a light-emitting diode (LED) array of an electronic device including multiple direct current to direct current (DCDC) converters, each DCDC converter being characterized with a predefined power conversion efficiency condition, the computing system comprising:
one or more hardware processors;
a memory;
a pool selector storable in the memory, executable by the one or more hardware processors, and configured to identify one or more DCDC converters of the multiple DCDC converters in the electronic device to apply a select voltage to at least one zone of the LED array, the select voltage corresponding to a brightness setting for the at least one zone of the LED array, wherein the one or more DCDC converters are identified to operate in satisfaction of the predefined power conversion efficiency condition for each DCDC converter when applying the select voltage to the at least one zone of the LED array; and
a DCDC converter activator storable in the memory, executable by the one or more hardware processors, and configured to apply the select voltage to the at least one zone of the LED array using the one or more DCDC converters.

9. The system of claim 8, wherein the select voltage applied by the one or more DCDC converters causes the at least one zone of the LED array to output light at the brightness setting.

10. The system of claim 8, further comprising:
a thermal output monitor stored in the memory, executable by the one or more hardware processors, and configured to determine that a temperature of a component of the electronic device is greater than a threshold temperature, wherein the pool selector is further configured to identify, based at least upon determining that the temperature is greater than the threshold temperature, the one or more DCDC converters based at least in part on a proximity of each of the multiple DCDC converters to the component.

11. The system of claim 10, wherein a first subset of the DCDC converters is resident on a first portion of the electronic device, wherein a second subset of the DCDC converters is resident on a second portion of the electronic device separate from the first portion.

12. The system of claim 11, wherein configured to identify the one or more DCDC converters comprises:
being configured to select the one or more DCDC converters from the first subset of the DCDC converters only, if a number of the one or more DCDC converters is less than or equal to a number of the DCDC converters in the first subset; and
being configured to select all of the first subset of the DCDC converters and one or more of the second subset of the DCDC converters, if the number of the one or more DCDC converters is greater than the number of the DCDC converters in the first subset.

13. The system of claim 11, wherein the first portion comprises a display portion of the electronic device.

14. The system of claim 11, wherein the first portion comprises a region outside of a display portion of the electronic device, wherein the component is a surface of the electronic device.

15. One or more tangible processor-readable storage media embodied with instructions for executing on one or more processors and circuits of a computing device a process for powering a light-emitting diode (LED) array of an electronic device including multiple direct current to direct current (DCDC) converters, each DCDC converter being characterized with a predefined power conversion efficiency condition, the process comprising:
determining a brightness setting for at least one zone of the LED array, wherein the brightness setting corresponds to a select voltage applied to the at least one zone of the LED array;
identifying one or more DCDC converters of the multiple DCDC converters in the electronic device to apply the select voltage to the at least one zone of the LED array, wherein the one or more DCDC converters are identified to operate in satisfaction of the predefined power conversion efficiency condition for each DCDC converter when applying the select voltage to the at least one zone of the LED array; and
applying the select voltage to the at least one zone of the LED array using the one or more DCDC converters.

16. The one or more tangible processor-readable storage media of claim 15, wherein the select voltage applied by the one or more DCDC converters causes the at least one zone of the LED array to output light at the brightness setting.

17. The one or more tangible processor-readable storage media of claim 15, wherein the identifying the one or more DCDC converters of the multiple DCDC converters further comprises:
determining that a temperature of a component of the electronic device is greater than a threshold temperature; and
based at least upon determining that the temperature is greater than the threshold temperature, identifying the one or more DCDC converters based at least in part on a proximity of each of the multiple DCDC converters to the component.

18. The one or more tangible processor-readable storage media of claim 17, wherein a first subset of the DCDC converters is resident on a first portion of the electronic device, wherein a second subset of the DCDC converters is resident on a second portion of the electronic device separate from the first portion.

19. The one or more tangible processor-readable storage media of claim 18, wherein identifying the one or more DCDC converters comprises:
selecting the one or more DCDC converters from the first subset of the DCDC converters only, if a number of the one or more DCDC converters is less than or equal to a number of the DCDC converters in the first subset; and
selecting all of the first subset of the DCDC converters and one or more of the second subset of the DCDC converters, if the number of the one or more DCDC converters is greater than the number of the DCDC converters in the first subset.

20. The one or more tangible processor-readable storage media of claim 18, wherein the first portion comprises a display portion of the electronic device.
